(19) United States
(12) Patent Application Publication
(10) Pub. No.: US 2013/0028567 A1
(43) Pub. Date: Jan. 31, 2013

(54) HIGH DENSITY OPTICAL FIBER DISTRIBUTION SYSTEM

(71) Applicants: Rutesh D. Parikh, Austin, TX (US); William G. Allen, Austin, TX (US)

(72) Inventors: Rutesh D. Parikh, Austin, TX (US); William G. Allen, Austin, TX (US)

(73) Assignee: 3M INNOVATIVE PROPERTIES COMPANY, St. Paul, MN (US)

(21) Appl. No.: 13/639,320

(22) PCT Filed: Mar. 10, 2011
(86) PCT No.: PCT/US2011/027909

§ 371 Date: Oct. 4, 2012

Related U.S. Application Data
(60) Provisional application No. 61/322,442, filed on Apr. 9, 2010.

(51) Int. Cl. G02B 6/36

(52) U.S. Cl. 385/135

(57) ABSTRACT

A high density optical fiber distribution system is disclosed which includes two columns of optical fiber termination blocks mounted on a standard telecommunication equipment rack. The rack includes a base and two vertical support members that define a bay. The optical fiber termination blocks are positioned on a front side of the rack and are mounted to one of the vertical support members by a mounting bracket. Each of the optical termination blocks includes a plurality of optical modules. The system can also include a vertical jumper slack storage portion adjacent to each column of optical fiber termination blocks, as well as a plurality of jumper routing troughs attached to a rear side of the rack.

### THE FIELD OF THE INVENTION

The present invention generally relates to connection systems for telecommunication cables, and more particularly to a high density optical fiber distribution system used to cross-connect and interconnect optical fibers used in telecommunications, the system providing improved management of jumper cables as well as storage and interconnection of fibers on a standard telecommunications rack.

### BACKGROUND OF THE INVENTION

In the field of telecommunications, conventional copper wires are being replaced by optical fiber transmission lines. Thus, it is necessary to provide a distribution and organizing facility for the fiber-optic cables at appropriate locations within exchanges inside telecommunication companies, office buildings or cabinets in the outside plant.

Typical distribution systems or optical distribution frames are used in the central office of telecommunication companies as manual patch panels for connecting outside plant optical cables with central office equipment. Conventional optical distribution frames may require large and/or specialized frame structures to provide access points on the optical network, which allow the connection to optical equipment, to other optical network equipment and/or to customer lines. The connections are made in optical fiber termination blocks, which are structures for actually mounting optical connection modules and optical devices.

Each optical connection module serves the purpose of connecting optical fibers of a main cable (the so-called network cable) and/or of distribution cables (station cables) to cables running to the customer or to an optical device. Alternatively, optical connection module may be used for interconnecting optical fibers of distribution cables. Often, the optical modules also contain storage space for spare length of optical fiber to facilitate removal/replacement of bad or under performing connections and replacement with new, more stable connections. Optical devices, on the other hand, perform functions within the network such as splitting (passive optical device) or amplification (active optical device). The optical connection module generally comprises a housing and cassettes supported by the housing for stowing optical fibers and fiber splices, and/or optical devices and an optical connector patch panel.

As telecommunication companies migrate to an optical fiber network, they will have to accommodate the infrastructure for both the existing copper network and the incoming newer fiber network. However, space within the central offices is usually limited. Thus, what is needed is a high density fiber distribution system that is both modular and expandable to allow for staged installation of the system and that can be accommodated on existing rack and frame structures rather than requiring the specialized frame systems that are currently available.

### SUMMARY OF THE INVENTION

The present invention provides a high density optical fiber distribution system. The distribution system is includes two columns of optical fiber termination blocks mounted on a rack. The rack includes a base and two vertical support members that define a bay. The optical fiber termination blocks are positioned on a front side of the rack and are mounted to one of the vertical support members by a mounting bracket. Each of the optical termination blocks includes a plurality of optical modules. The system can also include a vertical jumper slack storage portion adjacent to each column of optical fiber termination blocks, as well as a plurality of jumper routing troughs attached to a rear side of the rack.

In one exemplary embodiment, the rack is a standard 23 inch telecommunication equipment rack.

In an alternative exemplary embodiment, the high density optical fiber distribution system includes a patch panel in the optical modules. The patch panel comprises a plurality of optical fiber connector adapters for connecting an optical fiber cable inside the optical module and to a jumper cable disposed outside of the optical module.

### BRIEF DESCRIPTION OF THE DRAWINGS

The present invention will be further described with reference to the accompanying drawings, wherein:

FIG. 1A shows an isometric view of an exemplary high density fiber distribution system in accordance with the present invention.

FIG. 1B shows an isometric rear view of an exemplary rack for a high density fiber distribution system in accordance with the present invention.

FIG. 2 shows a partial exploded isometric view of an exemplary high density fiber distribution system in accordance with the present invention.

FIG. 3 shows a close-up rear view of a cable management trough of an exemplary high density fiber distribution system in accordance with the present invention.

FIG. 4A-4C show multiple isometric views of an exemplary optical fiber termination block for use in a high density fiber distribution system in accordance with the present invention.

FIG. 5 shows an isometric view of an exemplary optical module for use in a high density fiber distribution system in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a high density fiber distribution system which utilizes a standard telecommunication rack commonly used in the industry today. Specifically, the high density fiber distribution system, described herein, is modular and provides a higher density of connections than is currently available.

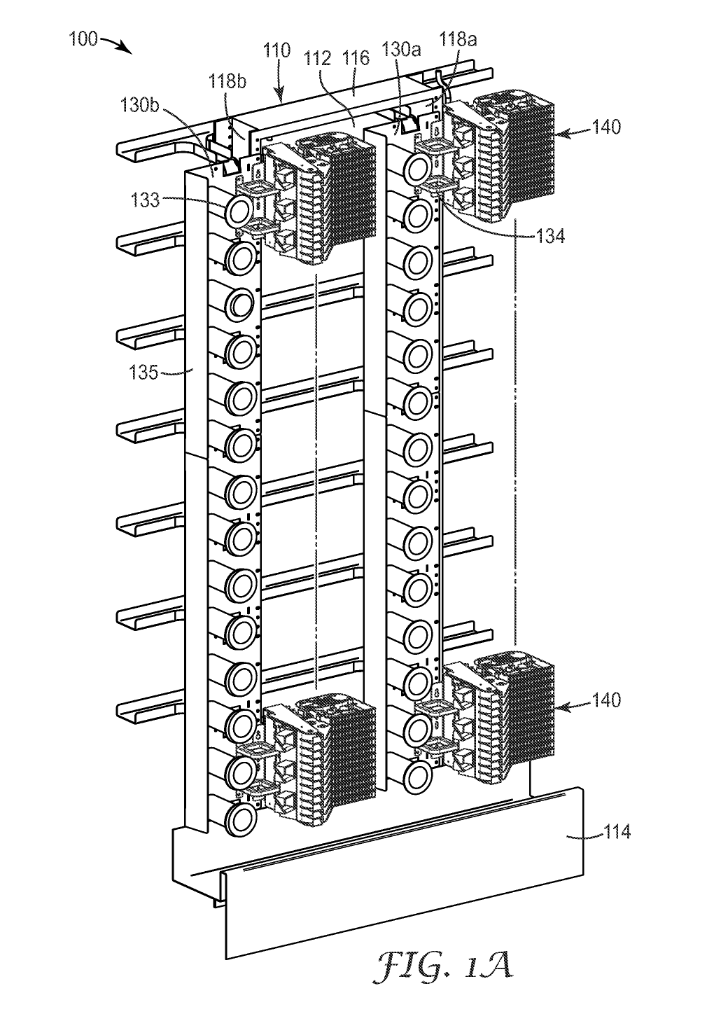

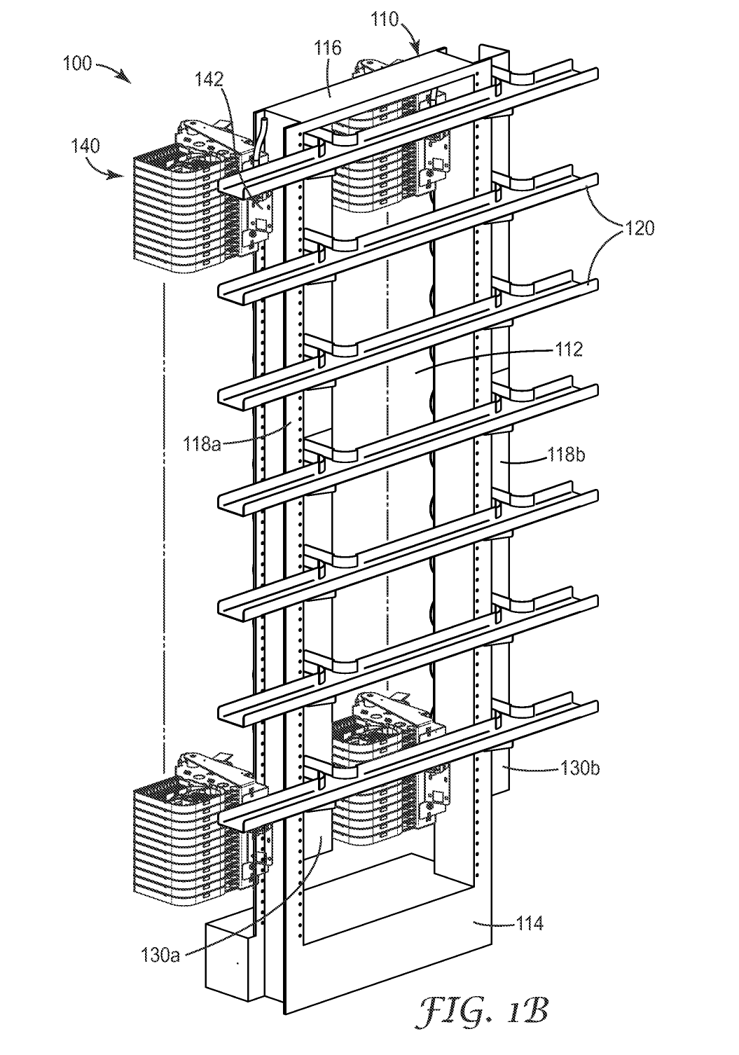

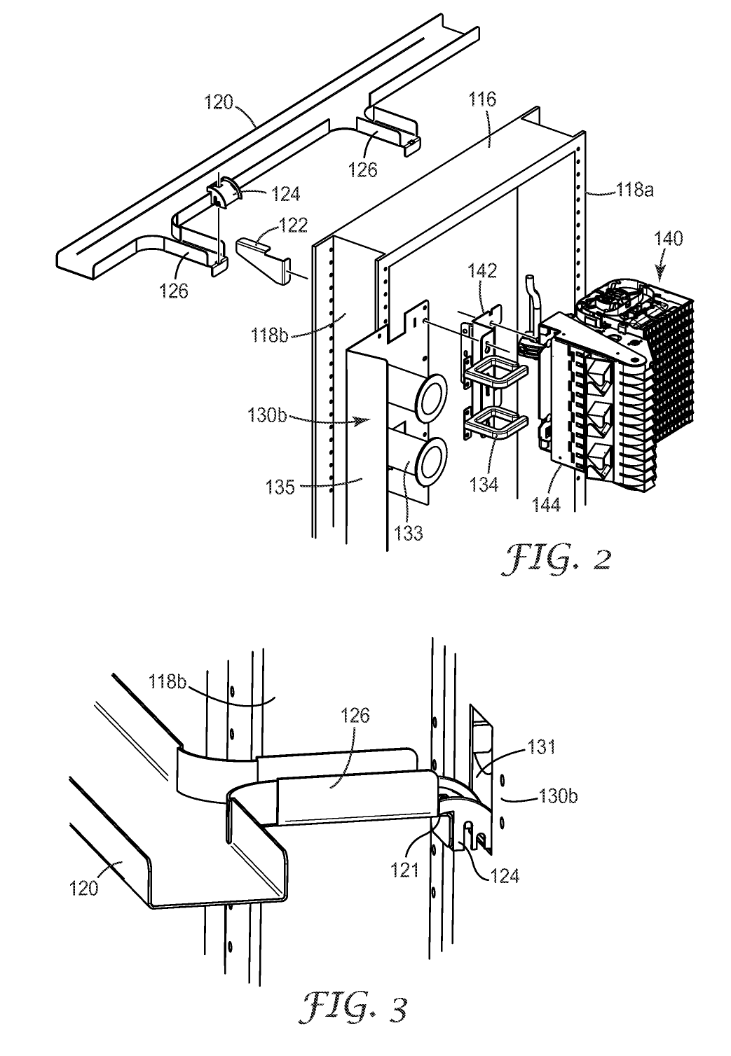

FIGS. 1A, 1B, and 2 show an exemplary embodiment of a high density fiber optic distribution system 100 of the present invention. Distribution system 100 includes a telecommunication rack 110 having a single bay 112 disposed between the base 114 and top cross member 116 of the rack and between the vertical support members 118a, 118b. Several optical fiber termination blocks 140 can be attached to each of the vertical support members 118a, 118b of rack 110, so that each rack supports two columns of optical fiber termination blocks. Thus, the optical fiber termination blocks are stacked vertically on rack 110. In particular, rack 110 may comprise a conventional 23 inch equipment rack formed of steel members which is commonly used in the telecommunications industry. These racks have a bay that is approximately 7 ft. high and 23 in. wide. While exemplary high density fiber optic distribution system has been described in reference to a 23 inch equipment rack, this should not be interpreted as a limitation of the current disclosure. It is anticipated that the exemplary distribution system could be used in conjunction with other standard racks used in the telecommunication system including a standard 19 inch equipment rack, European standard racks, or other standard racks used around the world.

Vertical jumper slack management portions 130a, 130b can also be attached the vertical support members 118a, 118b of rack 110. The vertical jumper slack management portions may be disposed adjacent to each column of optical fiber termination blocks 140 to aid in routing the jumper cables from one portion of distribution system 100 to another location on the same rack or assist in routing the jumpers to a different rack located at a second position within the facility. This configuration of optical fiber termination blocks enables a higher density of optical connections having a smaller foot print (e.g. requiring less floor space) than conventional optical distribution frame structures. Further, this design utilizes the same optical fiber termination blocks on both the left and right vertical support members thus reducing the complexity of the system.

Vertical jumper slack management portions can have a variety of cable management accessories such as fiber spool 133 and guide structures (e.g. hooks, rings 134, guide walls 135, etc.) to aid in the routing, cable management and slack storage of the jumpers terminated on distribution system 100.

In order to provide for the routing of jumpers between different racks, distribution system 100 may be provided with a plurality of jumper troughs 120 on the rear side of rack 110 as shown in FIG. 2. The main portion of the jumper trough (i.e. the portion that runs parallel to the back of the rack) may be offset or suspended some distance from the back of the rack. In this configuration, tributary troughs 126 can run from the main portion of the jumper troughs to the vertical jumper slack management portions 130a, 130b as shown in FIG. 3 such that the tributary troughs meat up with the main portion of the jumper troughs at a T-intersection wherein the corners have radius greater than the minimum bend radius of the jumpers to be guided within the troughs. Jumpers coming from the optical fiber termination block can pass through an opening 131 in the vertical jumper slack management portions and enter the tributary troughs 126 and subsequently enter the jumper troughs 120 on the rear side of the rack. The jumpers can then be routed through optical fiber raceways (not shown) in the central office to a point near their termination point where they will exit the raceway into another jumper trough so that they can be routed to another fiber termination block for connection.

The jumper troughs may be attached to the rear side of rack 100 by trough supports 122 (FIG. 2) attached to the vertical support members 118a, 118b by mechanical fasteners (not shown). In addition, a bend radius control adapter 124 can be provide at the point 121 where the jumper cables leave the jumper trough and pass through opening 131 in the vertical jumper slack management portion 130b as shown in FIG. 3.

Referring to FIGS. 2, 4A-4C and FIG. 5, an exemplary optical termination block 140 or modular cable head is described in U.S. Patent Publication No. 2010-0290751, and is incorporated by reference herein in its entirety. The optical fiber termination block 140 according to the present invention has a generally open, frame-like structure and comprises a mounting bracket 142 for attaching the optical termination block 140 to one of the vertical support members 118b of rack 110 and a mounting structure 144 for receiving a plurality of optical modules 150. A portion of the mounting structure can serve as a routing portion for routing fiber optic cables to and from the optical modules so as to respect the minimum bend radius of the fiber optic cables and to guide them from the network or station cable access point, such as a spreader subassembly, to the optical telecommunications modules 150 disposed on the mounting structure 144 and vice versa. The routing portion 145 may be plate-like and can include fiber optic cable holders (not shown) or means for appropriately holding and guiding fiber optic cables such as cable guide walls, hooks, loops or other suitable guide structures known in the art. The routing portion 145 can be used to store excess lengths of the incoming cable(s) in a protective tube to allow removal of the optical module from the optical fiber distribution block to a separate, more convenient work surface.

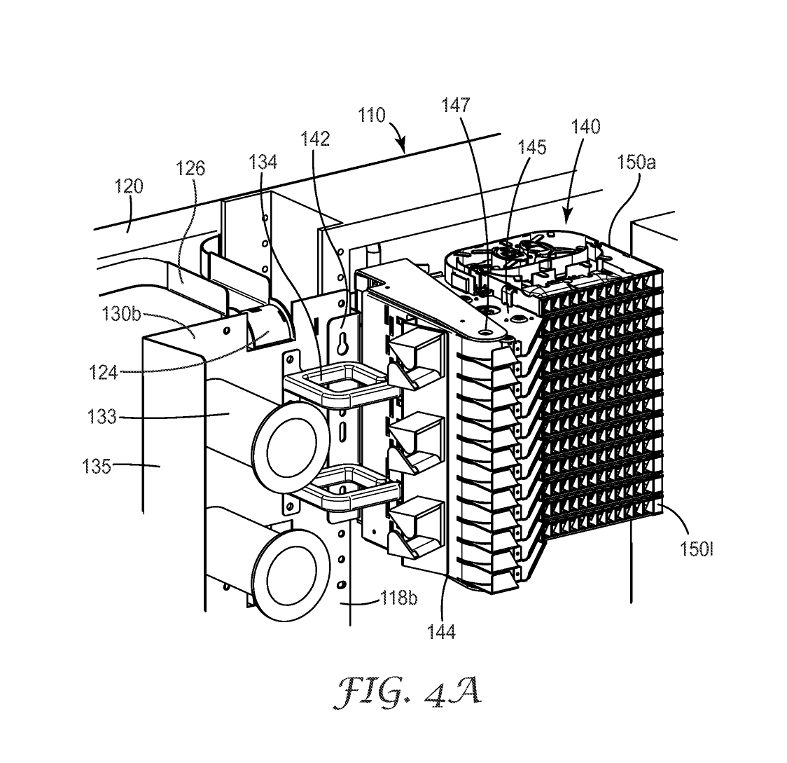

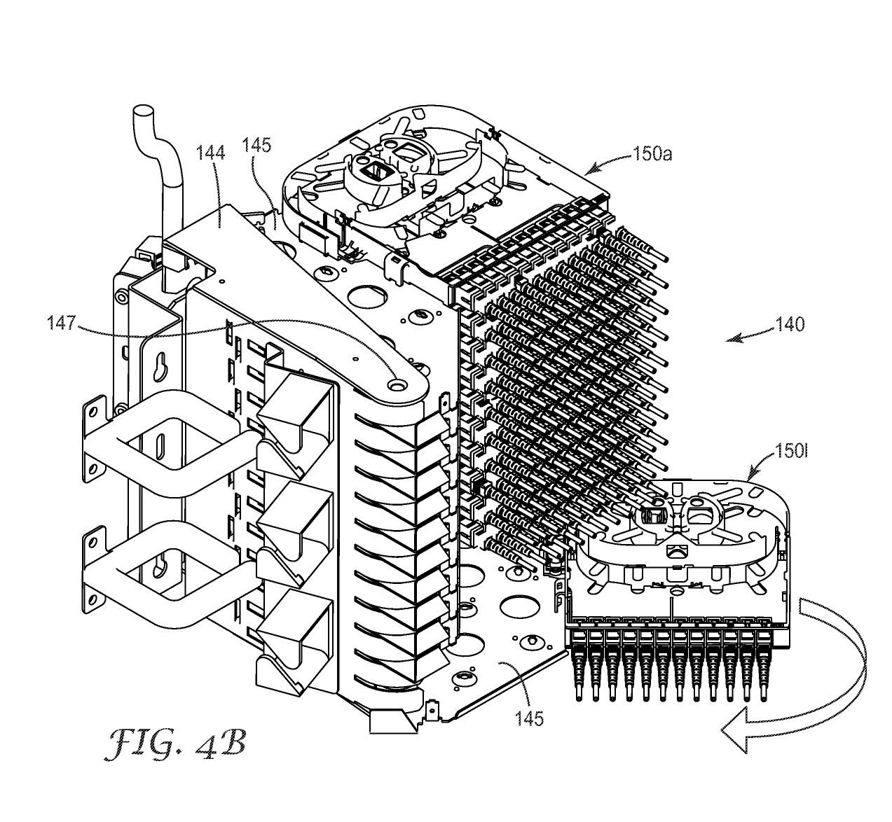

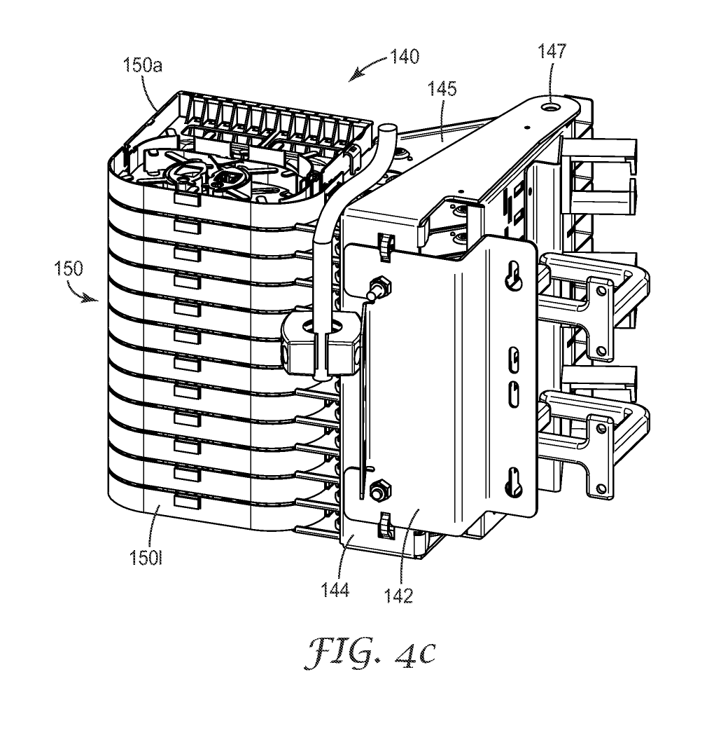

The mounting structure 144 comprises a plurality of routing plates 145 pivotally attached to the frame-like structure of the optical termination block in order to enable individual access to the individual routing plates by rotating them from their closed position (shown in FIG. 4A) to an open position. FIG. 4B shows the optical module/routing plate being moved from a closed position to an open position. A closed position, as used herein, here means a position in which the routing plate is located to some extent within the mounting structure for stowing and operating optical telecommunications elements, fiber-optic cables and/or devices, and an open position is understood to be a position in which an individual routing plate allows unhindered access thereto, for example for installation and/or maintenance. In this context, a plate can be a thin sheet-like element having two main surfaces on which optical telecommunication modules, fiber-optic cables and/or devices may be mounted.

The pivot axis 147 of the routing plate can be preferably arranged at an extremity of the routing plate 145 close to an accessible portion of the mounting structure 144, so that the plate, when pivoted into an open position, gives easy access to the holding and to provide full access to the fibers within the optical module and/or on routing plate. The pivot axis 147 of each routing plate can have any acceptable hinge structure that allows the routing plate to pivot in a direction perpendicular to the surface of the routing plate.

The routing plates 145 can be preferably be adapted to guide optical fiber cables coming out of one of said plurality of optical modules 150 in proximity of the pivot axis 147. The advantage of such an arrangement is that upon rotation of the routing plate from a closed position to an open position or visa-versa, the optical fibers of the cables are subjected to a minimal tensile stress due to the swinging of the optical module out of the mounting structure of optical termination block 140, and controlling bending radius of the fibers within a desired range.

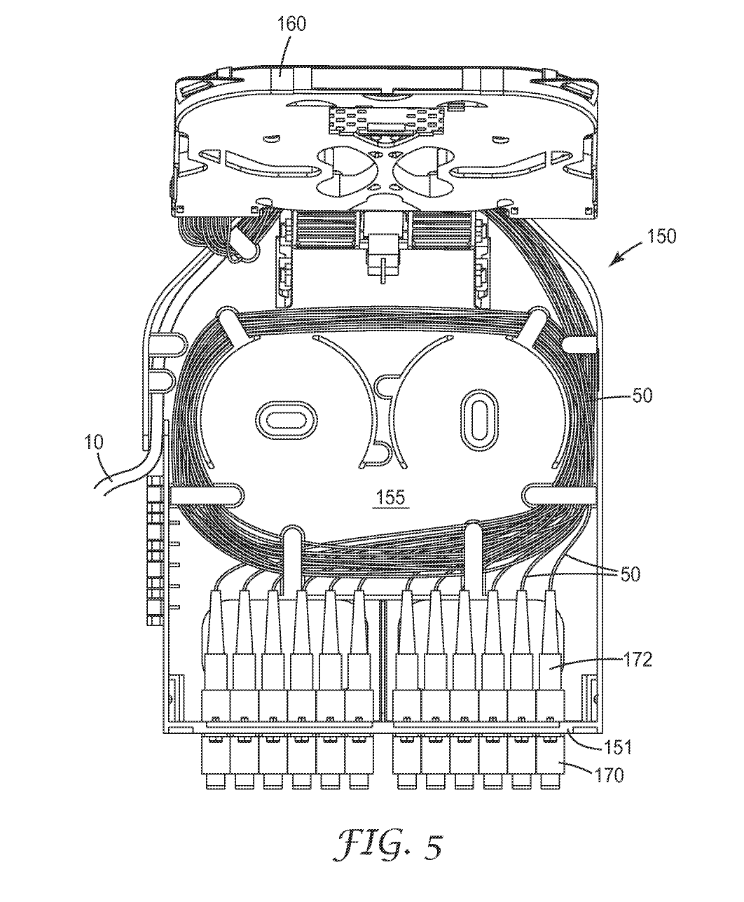

The optical fiber termination blocks shown in FIGS. 4A-4C have twelve optical modules 150a-150l disposed on a like number of pivotal routing plates 145. The optical modules 150 of the optical termination block 140 serve to establish connections between different signal transmitting optical fibers of the optical telecommunication network and to make connections within each optical module accessible outside of the optical module. Each optical module can include a plurality of optical connector adapters 170 through which optical connections are made by mating pairs of optical connectors. Optical module 150 shown in FIG. 5 has 12 connector adaptors 170 disposed in the front face 151 of the optical module. Thus, twelve optical connections may be made between optical fibers 50 disposed within the optical module to the same number of connections outside of the optical module. Therefore, each optical module 150 can include a plurality of connectors 172, for example 12 pigtails which have been spliced to twelve individual optical fibers from an incoming optical cable 10. Alternatively, the incoming optical cable fibers pre-terminated with optical connectors can be organized and stored in the optical module. In another alternative embodiment, one or more optical fibers from the incoming optical cable 10 can be spliced to the input and/or output ends of an optical device(s) (e.g. a m×n optical splitter). In a further alternative embodiment, the optical module can be used as a stand alone optical device module without any splicing to the main cable (i.e. all connections may be made through the patch panel on the front face of the module). Optical devices may comprise passive optical devices such as splitters, couplers, wavelength division multiplexers, and optical switches or active optical devices such as amplifiers. Thus, optical telecommunication module 150 can include one or more trays 160 to hold and secure optical fiber splices (e.g. mechanical or fusion splices) between incoming optical fibers and fiber pigtails or between incoming optical fibers and the optical devices housed within the optical module. The ability to utilize optical devices within the optical fiber termination block greatly enhances the flexibility of the block for a number of different applications or for use at several points within the optical network. This added flexibility enables the selection or expansion of capability at a lower cost. In addition, the compact foot print of the exemplary high density fiber optic distribution system 100 can provide significant space savings by eliminating large dedicated optical modules and distribution frames from the central office and/or other facility.

Within the optical module 150, connectors 172 can be provided with a length of residual optical fiber, which needs to be stored within the optical module. Thus, each optical module can include a slack cable storage portion 155 for storing this excess length of optical fiber, and one or more trays 160 adapted to secure optical fiber splices within the optical module. Tray 160, shown in FIG. 5, is hingedly attached to the slack storage portion 155 of optical module 150. Alternatively, one or more stackable trays may be disposed within optical module 150 and housed above the slack storage portion of the optical module.

In an alternative embodiment, field mount connectors may be attached to the incoming fibers within the optical module and residual lengths of the incoming fibers can be stored in the slack storage portion of the module. In this case, no tray is required in the optical module. Alternatively, the splicing can be integral with the slack storage portion of the optical module.

Optical connectors that are usable with the disclosed optical modules can include any conventional single fiber or multi-fiber connector format as dictated by the design architecture of the optical network. In addition, while the embodiments described herein describe optical modules having 12 optical connector adapters contained therein, this language should not be deemed as limiting as it is anticipated that more or fewer optical connectors may be disposed within a given optical module and is a matter of design choice and connector format.

Tray 160 may take up a certain amount of stored fiber in addition to the fiber splices. In this respect, it is advantageous if the tray is hingedly attached to optical module 150 or removable from the optical module to enable easy access to the slack cable storage portion 155. In addition, this configuration facilitates installation of new optical fiber lines by separating main storage space from the splicing space within the optical module.

The modular nature of distribution system 100 enables telecommunication companies to retrofit their existing network by adding new optical fiber capacity using existing racks. It is possible to build a novel distribution system in accordance with this invention that utilizes only a portion of a rack thus allowing new optical connections to be added with out the need of purchasing a large dedicated fiber distribution system which may only be partially utilized upon initial installation. Thus, the inventive system not only provides a high density distribution system, but also a cost affordable system which can be easily added to when additional optical fiber termination and cross connection capacity is needed.

In addition, because the exemplary distribution system is designed to be used with a standard telecommunication rack geometry and because of its modular nature, the exemplary distribution system can find uses in distributed networks such as in outside plant cabinets or premise equipment closets which house the requires rack structure.

Another advantage of the present invention is that each column of optical termination blocks has a dedicated vertical jumper slack storage portion which can improve the organization and slack storage of the jumpers routed on a given distribution system. This is especially helpful when one of the patch connections needs to be changed or disconnected because the improved organization makes it easier to follow a given jumper from one point to another on the rack, which helps prevent the inadvertent disconnection of other jumpers in the terminal block.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

1. A high density optical fiber distribution system, the system comprising;
a rack, wherein the rack includes a base and two vertical support members that define a bay;
two columns of optical fiber termination blocks disposed on the front side of the rack, each optical fiber termination block mounted to one of the vertical support members by a mounting bracket, wherein each of the optical termination blocks includes a plurality of optical modules;
a vertical jumper slack storage portion attached to each vertical support member and adjacent to each column of optical fiber termination blocks; and
a plurality of jumper routing troughs attached to a rear side of the rack.

2. The system of claim 1, wherein the rack is a standard 19 inch equipment rack.

3. The system of claim 1, wherein the rack is a standard 23 inch equipment rack.

4. The system of claim 1, wherein the optical module includes a patch panel comprising a plurality of optical fiber connector adapters for connecting the optical fiber cable inside the optical module and to a jumper cable disposed outside of the optical module.

5. The system of claim 4, wherein the patch panel is disposed in the front face of the optical module.

6. The system of claim 1, wherein the optical module includes at least one splice tray.

7. The system of claim 1, wherein the optical fiber termination block further includes at least one optical device module.
